(19) United States
(12) Patent Application Publication
(10) Pub. No.: US 2020/0317827 A1
(43) Pub. Date: Oct. 8, 2020

(54) PROCESS FOR UV CURING OF METHYLENE MALONATES

(71) Applicant: Sirrus, Inc., Loveland, OH (US)

(72) Inventors: Alexander R. Holzer, Cincinnati, OH (US); Anushree Deshpande, Loveland, OH (US); Aniruddha Palsule, Cincinnati, OH (US); Jeffrey M. Sullivan, Cincinnati, OH (US)

(21) Appl. No.: 16/629,727

(22) PCT Filed: Jul. 13, 2018
(86) PCT No.: PCT/US2018/041975

§ 371 Date: Jan. 9, 2020

Related U.S. Application Data
(60) Provisional application No. 62/532,408, filed on Jul. 14, 2017.

(51) Int. Cl. C08F 2/50; C08F 222/14; C08F 220/18; B05D 3/06; C08K 5/56; C08K 5/357; C08K 5/45; C08K 5/17; C08K 5/55

(52) U.S. Cl. CPC C08F 2/50; C08F 222/14; C08F 220/1811; B05D 3/067; B05D 5/08; C08K 5/357; C08K 5/45; C08K 5/17; C08K 5/55; C08K 5/56

(57) ABSTRACT

A method including forming a formulation by contacting one or more photoinitiators with a composition including one or more 1, 1-disubstituted alkene compounds having a purity of about 85 mole percent or more based on total weight of the 1, 1-disubsituted alkene compounds; and exposing the formulation to ultraviolet radiation for initiating free radical polymerization, anionic polymerization, or both, to cure the formulation to form a non-tacky surface. The teachings also contemplate a polymer prepared according to the methods as disclosed.

### CROSS-REFERENCE TO RELATED APPLICATIONS

The present application claims priority under 35 U.S.C. 119(e) to U.S. Provisional Application Ser. No. 62/532,408, filed Jul. 14, 2017, which is incorporated herein by reference in its entirety for all purposes.

### FIELD

The teachings herein are directed to formulations including one or more 1,1-disubstituted alkene compounds. Further disclosed are methods of forming the formulations including one or more initiators and curing the formulations, including using ultraviolet radiation.

### BACKGROUND

1,1-disubsituted alkene compounds, such as methylene malonates, contain two ester groups, and an alkylene group disposed between the two ester groups. Recent developments facilitate the synthesis of these compounds and their use in a variety of applications, see Malofsky U.S. Pat. Nos. 8,609,885; 8,884,051; and 9,108,914; incorporated herein by reference in their entireties for all purposes. Processes for transesterifying these compounds have also been recently developed. Malofsky et al. WO 2013/059473, U.S. Pat. Nos. 2014/0329980; and 9,512,058, incorporated herein by reference in their entirety for all purposes, discloses the preparation of multifunctional methylene malonates by multiple synthetic schemes. One disclosed process involves reacting a methylene malonate with a polyol in the presence of a catalyst to prepare compounds wherein one of the ester groups on the methylene malonates undergoes transesterification to react with the polyol and form multifunctional compounds (multifunctional meaning the presence of more than one methylene malonate core unit). The use of enzyme catalysis is disclosed. Sullivan, U.S. Pat. No. 9,416,091 discloses transesterification of 1,1-disubstituted-1-alkenes using certain acid catalysts, incorporated herein by reference in its entirety for all purposes.

Polymerization of 1,1-disubstituted alkene compounds can be performed in bulk state. The resulting polymerization process may be difficult to control, resulting in variable performance or mechanical properties, or in incomplete or uneven curing. Typically, the resulting polymer may be characterized by one or more of the following: a generally high level of branching, a high polydispersity index, a high concentration of non-polymer reaction products, a high concentration of monomers and/or oligomers, or a generally high viscosity.

As used herein, bulk polymerization refers to the polymerization of a polymerizable composition including one or more monomers where the concentration of the one or more monomers is about 80 weight percent or more, preferably about 90 weight percent or more (e.g., about 100 weight percent), based on the total weight of the compounds in the polymerizable composition that are liquid at room temperature. These polymerizations typically also require an input of energy either in the form of heat or radiation to initiate polymerization.

Free radical polymerization of dialkyl methylene malonate monomers using heat, UV light and peroxide is described in U.S. Pat. Nos. 2,330,033; and 2,403,791, both incorporated herein by reference. In these patents, the monomer was prepared using traditional methods which results in low purity monomer. The polymer examples in these patents are all prepared via bulk polymerization. One would therefore not expect to be able to control polymer properties, such as molecular weight and molecular weight distribution.

Commercially available UV cured systems are largely based on free radical chemistry of urethane and epoxy acrylates. However, a limitation of these types of technologies is the susceptibility to oxygen inhibition of free radicals that leads to a tacky exposed surface in several potting and encapsulating type applications.

Polymerization of 1,1-disubstituted alkene compounds using anionic polymerization processes are useful in the bulk polymerization of 1,1-disubstituted alkene compounds and processes which can operate at or near ambient conditions (starting conditions) have been disclosed. Such anionic bulk polymerizations may be initiated using a wide range of initiators, and may even be initiated by contact with certain substrates. However, compounds that fragment into basic analogues upon exposure to UV radiation have limited commercial appeal.

What is needed is a composition capable of being cured upon exposure to a UV light source, and associated methods of formulating the composition and curing the composition. What is also needed is a composition, which may be a coating, that exhibits enhanced properties, such as flexibility, adhesion to substrates, pencil hardness, solvent resistance, abrasion resistance, ultraviolet ray resistance, high temperature acid and base resistance, and the like. Processes that prepare the components for such coating and the coatings are also needed.

### SUMMARY

One aspect of the disclosure is directed at a process comprising the steps of: forming a formulation by contacting one or more photoinitiators with a composition including one or more 1,1-disubstituted alkene compounds; and exposing the formulation to ultraviolet radiation for initiating free radical polymerization, anionic polymerization, or both, to cure the formulation to form a non-tacky surface. The 1,1-disubstituted alkene compounds may have a purity of about 85 mole percent or more, about 90 mole percent or more, about 93 mole percent or more, about 97 mole percent or more, or about 99 mole percent or more based on total weight of the 1,1-disubsituted alkene compounds. The one or more 1,1-disubstituted alkene compounds may correspond to Formula 1:

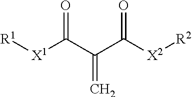

wherein X¹ and X², separately in each occurrence, are an oxygen atom or a direct bond; and
wherein R¹ and R², separately in each occurrence, are hydrocarbyl groups that are the same or different. The one or more 1,1-disubstituted alkene compounds may include ester groups corresponding to Formula 1A:

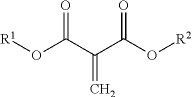

wherein R¹ and R², separately in each occurrence, are hydrocarbyl groups that are the same or different. The one or more 1,1-disubstituted alkene compounds may include keto groups corresponding to Formula 1B:

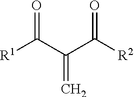

wherein R¹ and R², separately in each occurrence, are hydrocarbyl groups that are the same or different. The one or more 1,1-disubstituted alkene compounds may include one or more ester groups and one or more keto groups corresponding to Formula 10:

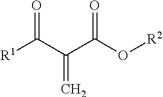

wherein R¹ and R², separately in each occurrence, are hydrocarbyl groups that are the same or different. The one or more 1,1-disubstituted alkene compounds may be multifunctional monomers corresponding to Formula 1D:

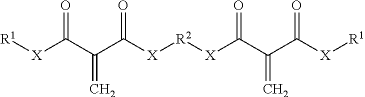

wherein X, separately in each occurrence, is an oxygen atom or a direct bond; wherein R¹ and R², separately in each occurrence, are hydrocarbyl groups that a the same or different; and n is an integer of 1 or greater.

The one or more 1,1-disubstituted alkene compounds may be methylene malonate monomers. The composition may include 1,1-disubstituted alkene compounds having two or more core units bound together through a hydrocarbylene linkage between one oxygen atom on each of two or more core formulas. The composition may include one or more (meth)acrylates or any other alkene containing unsaturated molecule that can be polymerized by free radicals.

The one or more photoinitiators may include alpha aminoketones, alpha hydroxyketones, phosphine oxides, phenylglyoxalates, thioxanthones, benzophenones, benzoin ethers, oxime esters, amine synergists, maleimides, or mixtures thereof. The one or more photoinitiators may be selected from 1,1-dibenzoyl ferrocene, 2-methyl-4′-(methylthio)-2-morphlinopropiophenone, the salt of tributylamine and tetraphenylborate, isopropylthioxanthone, or a combination thereof. The photoinitiator may be added to the composition including 1,1-disubstituted alkene compounds in an amount of about 0.1 percent by weight to about 6 percent by weight.

The method as disclosed herein may be performed at ambient temperatures. The ultraviolet light may have an irradiance between about 1 watt/cm² and about 5 watts/cm². The ultraviolet light may have a wavelength of about 250 nanometers to about 400 nanometers. For example the wavelength may be about 325 nanometers to about 375 nanometers. The formulation may be applied and cured in the form of a film or coating. The film or coating may be a tack-free film upon exposure to ultraviolet light. The formulation may be exposed to ultraviolet light for about 3 minutes or less. The formulation may be exposed to ultraviolet light for about 60 seconds or less.

The methods according to the teachings herein may include contacting a formulation as disclosed with a surface of a substrate. The substrate may be at least mildly nucleophilic. The method may include exposing the formulation to ultraviolet light. The formulation may be cured through at least part of, or through its entire thickness. The formulation may be cured by a combination of free radical and anionic cure. The substrate may have a pigmented coating deposited on its surface, where the pigmented coating may be mildly basic or nucleophilic.

The methods according to the teachings herein may be employed to produce a polymer including one or more 1,1-disubstituted alkene monomers.

The present teachings therefore contemplate a method and polymer resulting from the method that is capable of being cured by free radical photoinitiator chemistry and/or anionic photolatent base chemistry. The present teachings illustrate that the combination of free radical and anionic chemistry may help overcome the limitations of current free radical chemistry, so that cure depth is improved while reducing or eliminating the oxygen inhibition effect on the surface of the cured material.

### DETAILED DESCRIPTION

The explanations and illustrations presented herein are intended to acquaint others skilled in the art with the invention, its principles, and its practical application. The specific embodiments of the present invention as set forth are not intended to be exhaustive or limiting of the invention. The scope of the invention should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

Disclosed are compositions formed by contacting one or more initiators, such as photoinitiators and/or photobase generators, with a composition including one or more 1,1-disubstituted alkene compounds. Surprisingly, it has been found that a monomer including a 1,1-disubstituted alkene may be polymerized, free radically, anionically, or both, upon exposure to ultraviolet radiation to form a non-tacky surface of the polymer. A composition may be cured by both UV irradiation and anionic surface initiation, where the composition is applied to a basic surface of a substrate.

The formulation as disclosed herein may contain one or more monomers. The monomer typically includes one or more 1,1-disubstituted alkene compounds (e.g., one or more 1,1-disubstituted ethylene compounds). The 1,1-disubstituted alkene may be a primary monomer (i.e., a monomer present at 50 weight percent or more of a polymer block or of an entire polymer). 1,1-disubstituted alkene compounds are compounds (e.g., monomers) wherein a central carbon atom is doubly bonded to another carbon atom to form an ethylene group. The central carbon atom is further bonded to two carbonyl groups. Each carbonyl group is bonded to a hydrocarbyl group through a direct bond or an oxygen atom. Where the hydrocarbyl group is bonded to the carbonyl group through a direct bond, a keto group is formed. Where the hydrocarbyl group is bonded to the carbonyl group through an oxygen atom, an ester group is formed. The 1,1-disubstituted alkene may have a structure as shown below in Formula I, where X¹ and X² are an oxygen atom or a direct bond, and where R¹ and R² are each hydrocarbyl groups that may be the same or different. Both X¹ and X² may be oxygen atoms, such as illustrated in Formula IIA, one of X¹ and X² may be an oxygen atom and the other may be a direct bond, such as shown in Formula IIB, or both X¹ and X² may be direct bonds, such as illustrated in Formula IIC. The 1,1-disubstituted alkene compounds used herein may have all ester groups (such as illustrated in Formula IIA), all keto groups (such as illustrated in Formula IIC) or a mixture thereof (such as illustrated in Formula IIB). Compounds with all ester groups may be preferred in some applications due to the flexibility of synthesizing a variety of such compounds.

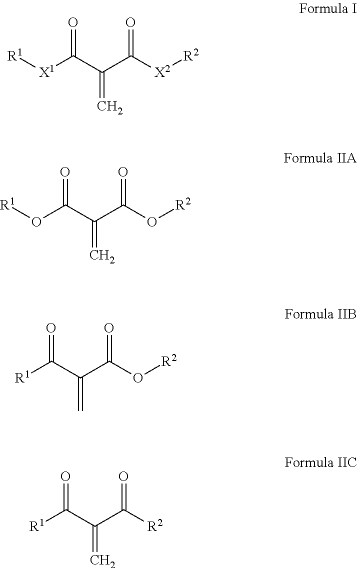

Unless defined otherwise, all technical and scientific terms used herein have the meaning commonly understood by a person skilled in the art to which this disclosure belongs. The following references provide one of skill with a general definition of many of the terms used in this disclosure: Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, The Harper Collins Dictionary of Biology (1991). As used herein, the following terms have the meanings ascribed to them below, unless specified otherwise.

One or more as used herein means that at least one, or more than one, of the recited components may be used as disclosed. Nominal as used with respect to functionality means the theoretical functionality, generally this can be calculated from the stoichiometry of the ingredients used. Generally, the actual functionality is different due to imperfections in raw materials, incomplete conversion of the reactants and formation of by-products. Durability in this context means that the composition once cured remains sufficiently strong to perform its designed function, in the embodiment wherein the cured composition is an adhesive, the adhesive holds substrates together for the life or most of the life of the structure containing the cured composition. Where the cured composition is a film, coating, or a sealant, the film or sealant adheres to one or more substrates for the life or most of the life of the structure containing the cured composition. As an indicator of this durability, the curable composition (e.g., adhesive, film, coating, or sealant) may exhibit excellent results during accelerated aging. Residual content of a component refers to the amount of the component present in free form or reacted with another material, such as a polymer. Typically, the residual content of a component can be calculated from the ingredients utilized to prepare the component or composition. Alternatively, it can be determined utilizing known analytical techniques. Heteroatom means nitrogen, oxygen, sulfur and phosphorus, more preferred heteroatoms include nitrogen and oxygen. Hydrocarbyl as used herein refers to a group containing one or more carbon atom backbones and hydrogen atoms, which may optionally contain one or more heteroatoms. Where the hydrocarbyl group contains heteroatoms, the heteroatoms may form one or more functional groups well known to one skilled in the art. Hydrocarbyl groups may contain cycloaliphatic, aliphatic, aromatic or any combination of such segments. The aliphatic segments can be straight or branched. The aliphatic and cycloaliphatic segments may include one or more double and/or triple bonds. Included in hydrocarbyl groups are alkyl, alkenyl, alkynyl, aryl, cycloalkyl, cycloalkenyl, alkaryl and aralkyl groups. Cycloaliphatic groups may contain both cyclic portions and noncyclic portions. Hydrocarbylene means a hydrocarbyl group or any of the described subsets having more than one valence, such as alkylene, alkenylene, alkynylene, arylene, cycloalkylene, cycloalkenylene, alkarylene and aralkylene. One or both hydrocarbyl groups may consist of one or more carbon atoms and one or more hydrogen atoms. As used herein percent by weight or parts by weight refer to, or are based on, the weight of the solution composition unless otherwise specified.

1,1-disubstituted alkene compound means a compound having a carbon with a double bond attached thereto and which is further bonded to two carbon atoms of carbonyl groups. A preferred class of 1,1-disubstituted alkene compounds are the methylene malonates which refer to compounds having the core formula:

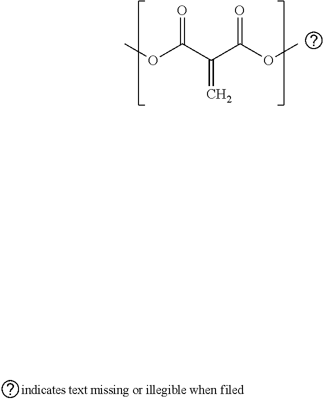

The term “monofunctional” ref mpounds or a methylene malonate having only one cor refers to 1,1-disubstituted alkene compounds or a methy ormulas bound through a hydrocarbyl linkage between core formulas. The term “multifunctional” refers to 1,1-disubstituted alkene compounds or methylene malonates having more than one core formula which forms a chain through a hydrocarbyl linkage between one oxygen atom on each of two adjacent core formulas. A 1,1-disubstituted alkene compound may be a 1,1-diester-1-alkene. As used herein, diester refers to any compound having two ester groups. A 1,1-diester-1-alkene is a compound that contains two ester groups and a double bond bonded to a single carbon atom referred to as the one carbon atom. Dihydrocarbyl dicarboxylates are diesters having a hydrocarbylene group between the ester groups wherein a double bond is not bonded to a carbon atom which is bonded to two carbonyl groups of the diester. The term “ketal” refers to a molecule having a ketal functionality—i.e., a molecule containing a carbon bonded to two —OR groups, where O is oxygen and R represents any alkyl group. The terms “volatile” and “non-volatile” refer to a compound that is capable of evaporating readily at normal temperatures and pressures, in the case of volatile, or which is not capable of evaporating readily at normal temperatures and pressures, in the case of non-volatile. As used herein, the term “stabilized” (e.g., in the context of “stabilized” 1,1-disubstituted alkene compounds or monomer compositions comprising same) refers to the tendency of the compounds (or the monomer compositions), prior to activation with an activator, to substantially not polymerize with time, to substantially not harden, form a gel, thicken, or otherwise increase in viscosity with time, and/or to substantially show minimal loss in cure speed (i.e., cure speed is maintained) with time. As used herein, the term “shelf-life” (e.g., as in the context of 1,1-disubstituted alkene compounds having an improved “shelf-life”) refers to the 1,1-disubstituted alkene compounds which are stabilized for a given period of time; e.g., 1 month, 6 months, or even 1 year or more.

The hydrocarbyl groups (e.g., R¹ and R²), each may comprise straight or branched chain alkyl, straight or branched chain alkyl alkenyl, straight or branched chain alkynyl, cycloalkyl, alkyl substituted cycloalkyl, aryl, aralkyl, or alkaryl. The hydrocarbyl group may optionally include one or more heteroatoms in the backbone of the hydrocarbyl group. The hydrocarbyl group may be substituted with a substituent that does not negatively impact the ultimate function of the monomer or the polymer prepared from the monomer. Preferred substituents include alkyl, halo, alkoxy, alkylthio, hydroxyl, nitro, cyano, azido, carboxy, acyloxy, and sulfonyl groups. More preferred substituents include alkyl, halo, alkoxy, alylthio, and hydroxyl groups. Most preferred substituents include halo, alkyl, and alkoxy groups.

As used herein, alkaryl means an alkyl group with an aryl group bonded thereto. As used herein, aralkyl means an aryl group with an alkyl group bonded thereto and include alkylene bridged aryl groups such as diphenyl methyl groups or diphenyl propyl groups. As used herein, an aryl group may include one or more aromatic rings. Cycloalkyl groups include groups containing one or more rings, optionally including bridged rings. As used herein, alkyl substituted cycloalkyl means a cycloalkyl group having one or more alkyl groups bonded to the cycloalkyl ring.

The hydrocarbyl groups may include 1 to 30 carbon atoms, 1 to 20 carbon atoms, or 1 to 12 carbon atoms. Hydrocarbyl groups with heteroatoms in the backbone may be alkyl ethers having one or more alkyl ether groups or one or more alkylene oxy groups. Alkyl ether groups may be ethoxy, propoxy, and butoxy. Such compounds may contain from about 1 to about 100 alkylene oxy groups, about 1 to about 40 alkylene oxy groups, about 1 to about 12 alkylene oxy groups, or about 1 to about 6 alkylene oxy groups.

One or more of the hydrocarbyl groups (e.g., R¹, R², or both) may include a C₁₋₁₅ straight or branched chain alkyl, a C₁₋₁₅ straight or branched chain alkenyl, a C₅₋₁₈ cycloalkyl, a C₆₋₂₄ alkyl substituted cycloalkyl, a C₄₋₁₈ aryl, a C₄₋₂₀ aralkyl, or a C₄₋₂₀ aralkyl. The hydrocarbyl group may include a C₁₋₈ straight or branched chain alkyl, a C₅₋₁₂ cycloalkyl, a 0612 alkyl substituted cycloalkyl, a C₄₋₁₈ aryl, a C₄₋₂₀ aralkyl, or a C₄₋₂₀ aralkyl.

Alkyl groups may include methyl, propyl, isopropyl, butyl, tertiary butyl, hexyl, ethyl pentyl, and hexyl groups. More preferred alkyl groups include methyl and ethyl. Cycloalkyl groups may include cyclohexyl and fenchyl. Alkyl substituted groups may include menthyl and isobornyl.

Hydrocarbyl groups attached to the carbonyl group may include methyl, ethyl, propyl, isopropyl, butyl, tertiary, pentyl, hexyl, octyl, fenchyl, menthyl, and isobornyl.

Monomers may include methyl propyl methylene malonate, dihexyl methylene malonate, di-isopropyl methylene malonate, butyl methyl methylene malonate, ethoxyethyl ethyl methylene malonate, methoxyethyl methyl methylene malonate, hexyl methyl methylene malonate, dipentyl methylene malonate, ethyl pentyl methylene malonate, methyl pentyl methylene malonate, ethyl ethylmethoxy methylene malonate, ethoxyethyl methyl methylene malonate, butyl ethyl methylene malonate, dibutyl methylene malonate, diethyl methylene malonate (DEMM), diethoxy ethyl methylene malonate, dimethyl methylene malonate, di-N-propyl methylene malonate, ethyl hexyl methylene malonate, methyl fenchyl methylene malonate, ethyl fenchyl methylene malonate, 2 phenylpropyl ethyl methylene malonate, 3 phenylpropyl ethyl methylene malonate, and dimethoxy ethyl methylene malonate.

Some or all of the 1,1-disubstituted alkenes can also be multifunctional, having more than one core unit and thus more than one alkene group. Exemplary multifunctional 1,1-disubstituted alkenes are illustrated by the formula:

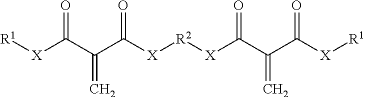

wherein R¹ and R² are as previously defined; X is, separately in each occurrence, an oxygen atom or a direct bond; n is an integer of 1 or greater; and R is a hydrocarbyl group, and the 1,1-disubstituted alkene has n+1 alkenes. In the formula, n may be 1 to about 7, 1 to about 3, or 1. In exemplary embodiments R² may be, separately in each occurrence, straight or branched chain alkyl, straight or branched chain alkenyl, straight or branched chain alkynyl, cycloalkyl, alkyl substituted cycloalkyl, aryl, aralkyl, or alkaryl, wherein the hydrocarbyl groups may contain one or more heteroatoms in the backbone of the hydrocarbyl group and may be substituted with a substituent that does not negatively impact the ultimate function of the compounds or polymers prepared from the compounds. Exemplary substituents may be those disclosed as useful with respect to R¹. In certain embodiments R² may be, separately in each occurrence, C₁₋₁₅ straight or branched chain alkyl, C₂₋₁₅ straight or branched chain alkenyl, C₅₋₁₈ cycloalkyl, C₆₋₂₄ alkyl substituted cycloalkyl, C₄₋₁₈ aryl, C₄₋₂₀ aralkyl or C₄₋₂₀ aralkyl groups. In certain embodiments R² may be separately in each occurrence C₁₋₈ straight or branched chain alkyl, C₅₋₁₂ cycloalkyl, C₆₋₁₂ alkyl substituted cycloalkyl, C₄₋₁₈ aryl, C₄₋₂₀ aralkyl or C₄₋₂₀ alkaryl groups.

According to the teaching herein, the one or more monomers may include a co-monomer that is a 1,1-disubstituted alkene compound having a hydrocarbyl group bonded to each of the carbonyl groups through a direct bond (e.g., a carbon-carbon bond) or an oxygen atom, such as a monomer having one or more features described above. If included, a co-monomer may optionally be a monomer that is not a 1,1-disubstituted alkene compound. Any co-monomer capable of anionic or free radical polymerization may be employed. For example, the co-monomer may be capable of forming a random copolymer with a 1,1-disubstituted alkene compound, capable of forming a block copolymer with a 1,1-disubstituted alkene compound, or both.

The 1,1-disubstituted alkene compound may be prepared using a method which results in a sufficiently high purity so that it can be polymerized. The purity of the 1,1-disubstituted alkene compound may be sufficiently high so that 70 mole percent or more, 80 mole percent or more, 90 mole percent or more, 95 mole percent or more, or 99 mole percent or more of the 1,1-disubstituted alkene compound is converted to polymer during a polymerization process. The purity of the 1,1-disubstituted alkene compound may be about 85 mole percent or more, about 90 mole percent or more, about 93 mole percent or more, about 95 mole percent or more, about 97 mole percent or more, or about 99 mole percent or more, based on the total weight of the 1,1-disubstituted alkene compound. If the 1,1-disubstitute alkene compound includes impurities, about 40 mole percent or more, or about 50 mole percent or more of the impurity molecules are the analogous 1,1-disubstited alkane compound. The concentration of any impurities having a dioxane group may be about 2 mole percent or less, about 1 mole percent or less, about 0.2 mole percent or less, or about 0.05 mole percent or less, based on the total weight of the 1,1-disubstituted alkene compound. The total concentration of any impurity having the alkene group replaced by an analogous hydroxyalkyl group (e.g., by a Michael addition of the alkene with water), may be about 3 mole percent or less, about 1 mole percent or less, about 0.1 mole percent or less, or about 0.01 mole percent or less, based on the total moles in the 1,1-disubstituted alkene compound. 1,1-disubstituted alkene compounds may be prepared by a process including one or more (e.g., two or more) steps of distilling a reaction product or an intermediate reaction product (e.g., a reaction product or intermediate reaction product of a source of formaldehyde and a malonic acid ester).

The 1,1-disubstituted alkene compound may include a monomer produced according to the teachings of U.S. Pat. No. 8,609,885 (Malofsky et al.) incorporated herein by reference in its entirety. Other examples of monomers which may be employed include the monomers taught in International Patent Application Publication Nos. WO 2013/066629 and WO 2013/059473, and U.S. Pat. Nos. 9,221,739; 9,512,058; and 9,527,795, all of which are incorporated herein by reference.

The composition disclosed may contain 1,1-disubstituted alkene-containing structures, including polyester macromers, which may contain one or more chains containing the residue of one or more diols and one or more diesters wherein a portion of the diesters may comprise 1,1-diester-1-alkenes. The residue of the diols and the diesters can alternate along the chains or can be disposed randomly along the chains. The diesters may further comprise any diester compound that will undergo transesterification with a polyol or diol. Among diester compounds are dihydrocarbyl dicarboxylates. The 1,1-disubstituted alkene-containing compounds, such as polyester macromers, may have three or more chains as described. The 1,1-disubstituted alkene-containing compounds, such as polyester macromers, having three or more chains contain the residue of a polyol originally having three or greater hydroxyl groups. The three or more chains may propagate from each of the three or more hydroxyl groups. The polyols having three or more chains may function as initiators from which each of the chains of the 1,1-disubstituted alkene-containing compounds, such as polyester macromers, propagate. If the polyol is a diol a single chain is produced because the macromer formed is linear. Where a polyol having three or more hydroxyls is used to prepare the macromer, it may have two or more chains as not all of the hydroxyls may propagate chains. The macromers may contain one or more chains, may contain two or more chains, or may contain three or more chains. The macromers may contain eight or less chains, six or less chains, four or less chains or three or less chains. The chains may comprise the residue of one or more polyols, one or more diols and one or more diesters, including one or more 1,1-diester-1-alkenes and optionally one or more dihydrocarbyl dicarboxylates. The chains may comprise the residue of one or more diols and one or more diesters, including one or more 1,1-diester-1-alkenes and optionally one or more dihydrocarbyl dicarboxylates. The 1,1-disubstituted alkene-containing compounds, such as polyester macromers, contain the residue of at least one 1,1-diester-1-alkenes at the terminal end of one of the chains. The 1,1-disubstituted alkene-containing compounds, such as polyester macromers, may further comprise one or more diols or dihydrocarbyl dicarboxylates at the terminal end of one or more of the chains. Substantially all of the terminal ends of chains may be 1,1-diester-substituted alkenes.

The 1,1-disubsituted alkene compounds, and the formulations formed including these 1,1-disubstited alkene compounds may contain in their backbone repeating units comprising the residue of at least one diester and one diol. A significant portion of the diesters may be 1,1-diester-substituted-1-alkenes. A portion of the diesters may be 1,1-dihydrocarbyl dicarboxylates. The backbone of 1,1-disubstituted alkene-containing compounds, such as polyester macromers, contain a sufficient number of repeating units comprising the residue of at least one diester and one diol to facilitate the use of the 1,1-disubstituted alkene-containing compounds, such as polyester macromers, as disclosed herein such as in coatings, films, fibers, particles and the like. The number of repeating units comprising the residue of at least one diester and one diol in 1,1-disubstituted alkene-containing compounds may be 2 or greater, 4 or greater or 6 or greater. The number of repeating units comprising the residue of at least one diester and one diol in 1,1-disubstituted alkene-containing compounds may be 10 or less, 8 or less, or 6 or less. The diesters in some 1,1-disubstituted alkene-containing compounds can be all 1,1-diester-1-alkenes. The diesters in some 1,1-disubstituted alkene-containing compounds can be 1,1-diester-1-alkenes and dihydrocarbyl dicarboxylates. The ratio of 1,1-diester-1-alkenes and dihydrocarbyl dicarboxylates in some 1,1-disubstituted alkene-containing compounds is selected to provide the desired degree of crosslinking in structures prepared from the 1,1-disubstituted alkene-containing compounds. The ratio of 1,1-diester-1-alkenes and dihydrocarbyl dicarboxylates in some 1,1-disubstituted alkene-containing compounds may be 1:1 or greater, 6:1 or greater or 10:1 or greater. The ratio of 1,1-diestersubstituted-1-alkenes and dihydrocarbyl dicarboxylates in some 1,1-disubstituted alkene-containing compounds may be 15:1 or less, 10:1 or less, 6:1 or less or 4:1 or less. The 1,1-disubstituted alkene-containing compounds, such as polyester macromers, may exhibit a number average molecular weight of about 600 or greater, about 900 or greater, about 1000 or greater or about 1200 or greater. The 1,1-disubstituted alkene-containing compounds, such as polyester macromers, may exhibit a number average molecular weight of about 3000 or less, about 2000 or less or about 1600 or less. Number average molecular weight as used herein is determined dividing total weight of all the polymer molecules in a sample, by the total number of polymer molecules in a sample. The polydispersity of the 1,1-disubstituted alkene-containing compounds, such as polyester macromers, may be about 1.05 or greater or about 1.5 or greater. The polydispersity of the 1,1-disubstituted alkene-containing compounds, such as polyester macromers, may be about 5 or less or about 3.5 or less. For calculating the polydispersity the weight average molecular weight is determined using gel permeation chromatography using a polymethylmethacrylate standard.

The 1,1-disubstituted alkene-containing compounds, such as polyester macromers, disclosed may be prepared from 1,1-diester-1-alkenes, diols, polyols and/or dihydrocarbyl dicarboxylates. The choice of specific ingredients, ratios of ingredients and sequence of process steps impact the final structure and content of the 1,1-disubstituted alkene-containing compounds. The presence of polyols having greater than two hydroxyl groups function to initiate the chains results in the formation of a polyester macromer having more than two chains, that is the macromer exhibits branching and the polymer is not linear. The 1,1-diester-1-alkenes help form the chains and introduce pendant alkene groups capable of crosslinking via anionic and/or free radical polymerization. The diols may initiate a single chain and chain extend the 1,1-disubstituted alkene-containing compounds. The dihydrocarbyl dicarboxylates help form the chains and function to space the pendant alkene groups from one another, thereby increasing the distance between crosslinks and the average molecular weight per crosslink.

The 1,1-disubstituted alkene-containing compounds, such as polyester macromers, may comprise sufficient amount of the residue of one or more polyols, in this context the polyols have 3 or greater hydroxyl groups, to initiate the desired number of chains. The residue of the polyols in the polyester macromers may be about 20 mole percent or greater of the macromer; 30 mole percent or greater or about 40 mole percent or greater. The residue of the polyols in the polyester macromers may be about 50 mole percent or less; or about 40 mole percent or less. The polyester macromers may comprise sufficient amount of the residue of one or more diols, in this context the polyols have 2 hydroxyl groups, to prepare polyester macromers having the desired chain length and number average molecular weight. The residue of the diols in the polyester macromers may be about 20 mole percent or greater of the macromer; 40 mole percent or greater or about 50 mole percent or greater. The residue of the diols in the polyester macromers may be about 50 mole percent or less; 40 mole percent or less or about 30 mole percent or less. The polyester macromers may comprise sufficient amount of the residue of the 1,1-diester-substituted-1-alkenes to provide the desired crosslink density to compositions containing the polyester macromers. The residue of the 1,1-diester-substituted-1-alkenes in the polyester macromers may be about 20 mole percent or greater of the macromer; 30 mole percent or greater or about 40 mole percent or greater. The residue of the 1,1-diester-substituted-1-alkenes in the polyester macromers may be about 60 mole percent or less of the macromer; about 50 mole percent or less of the macromer; about 40 mole percent or less or about 30 mole percent or less. The polyester macromers may comprise sufficient amount of the residue of the dihydrocarbyl dicarboxylates to provide the desired space between crosslinks to compositions containing the polyester macromers to provide the desired flexibility and/or elasticity to the structures containing the polyester macromers. The residue of the dihydrocarbyl dicarboxylates in the polyester macromers may be about 10 mole percent or greater of the polyester macromer; 20 mole percent or greater or about 30 mole percent or greater. The residue of the dihydrocarbyl dicarboxylates in the polyester macromers may be about 30 mole percent or less of the polyester macromer; 20 mole percent or less or about 10 mole percent or less.

Polyols useful are compounds having a hydrocarbylene backbone with two or more hydroxyl groups bonded to the hydrocarbylene backbone and which may capable of transesterifying ester compounds under the transesterification conditions disclosed herein. Polyols useful herein fall in two groups. The first group are diols which have two hydroxyl groups bonded to a hydrocarbylene backbone and which function both to initiate and extend the chains of the polyester macromers. Polyols with greater than two hydroxyl groups bonded to the hydrocarbylene backbone function to initiate more than two chains. Diols may also function to extend the more than two chains. The polyols may have from 2 to 10 hydroxyl groups, from 2 to 4 hydroxyl groups or from 2 to 3 hydroxyl groups. The backbone for the polyols, including diols, may be alkylene, alkenylene, cycloalkylene, heterocyclylene, alkyl heterocyclylene, arylene, aralkylene, alkarylene, heteroarylene, alkheteroarylene, or polyoxyalkylene. The backbone may be C₁-C₁₅ alkylene, C₂-C₁₅ alkenylene, C₃-C₉ cycloalkylene, C₂₋₂₀ heterocyclylene, C₃₋₂₀ alkheterocyclylene, C₆₋₁₈ arylene, C₇₋₂₅ alkarylene, C₇₋₂₅ aralkylene, C₅₋₁₈ heteroarylene, C₆₋₂₅ alkyl heteroarylene or polyoxyalkylene. The alkylene sections may be straight or branched. The recited groups may be substituted with one or more substituents which do not interfere with the transesterification reaction. Exemplary substituents include halo alkylthio, alkoxy, hydroxyl, nitro, azido, cyano, acyloxy, carboxy, or ester. The backbone may be C₂₋₁₀ alkylene groups. The backbone may be a C₂₋₈ alkylene group, which may be straight or branched, such as ethylene, propylene, butylene, pentylene, hexylene, 2-ethyl hexylene, heptylene, 2-methyl 1,3 propylene or octylene. The diols having a methyl group at the 2 position of an alkylene chain may be used. Exemplary diols include ethane diol, propane diol, butane diol, pentane diol, hexane diol, 2 ethyl hexane diol, heptane diol, octane diol, 2-methyl 1,3 propylene glycol, neopentyl glycol and 1,4-cyclohexanol. The polyol may correspond to the following formula: R²OH)_{c};

the diol may correspond to the following formula: HO—R²—OH;
wherein R² is separately in each occurrence a hydrocarbylene group having two or more bonds to the hydroxyl groups of a polyol. R² may be separately in each occurrence alkylene, alkenylene, cycloalkylene, heterocyclylene, alkyl heterocyclylene, arylene, aralkylene, alkarylene, heteroarylene, alkheteroarylene, or polyoxyalkylene. R² may be separately in each occurrence C₁-C₁₅ alkylene, C₂-C₁₅ alkenylene, C₃-C₉ cycloalkylene, C₂₋₂₀ heterocyclylene, C₃₋₂₀ alkheterocyclylene, C₆₋₁₈ arylene, C₇₋₂₅ alkarylene, C₇₋₂₅ aralkylene, C₅₋₁₈ heteroarylene, C₆₋₂₅ alkyl heteroarylene or polyoxyalkylene. The recited groups may be substituted with one or more substituents which do not interfere with the transesterification reaction. Exemplary substituents include halo, alkylthio, alkoxy, hydroxyl, nitro, azido, cyano, acyloxy, carboxy, or ester. R² may be separately in each occurrence a C₂₋₈ alkylene group, such as ethylene, propylene, butylene, pentylene, hexylene, 2-ethyl hexylene, heptylene, 2-methyl 1,3 propylene or octylene. Exemplary C3-C9 cycloalkylenes include cyclohexylene. The alkylene groups may be branched or straight and may have a methyl group on the 2 carbon. Among preferred alkarylene polyols are polyols with the structure of -aryl-alkyl-aryl- (such as -phenyl-methyl-phenyl- or -phenyl-propyl-phenyl-) and the like. Among preferred alkyl cycloalkylene poly-yls are those with the structure of -cycloalkyl-alkyl-cycloalkyl- (such as -cyclohexyl-methyl-cyclohexyl- or -cyclohexyl-propyl-cyclohexyl-) and the like. c may be an integer of 8 or less, 6 or less, 4 or less, or 3 or less and c may be an integer of 1 or greater, 2 greater or 3 or greater.

The one or more dihydrocarbyl dicarboxylates are compounds with two ester groups having a hydrocarbylene group disposed between the ester groups. The one or more dihydrocarbyl dicarboxylates comprise one or more of aromatic dicarboxylates, aliphatic dicarboxylates and cycloaliphatic dicarboxylates or may be one or more dihydrocarbyl dicarboxylates wherein one of the hydrocarbyl groups is aliphatic, cycloaliphatic or aromatic and the other is selected from another class of aliphatic, cycloaliphatic or aromatic. The one or more dihydrocarbyl dicarboxylates comprise one or more of aromatic dicarboxylates having 8 to 14 carbon atoms in the backbone, aliphatic dicarboxylates having 1 to 12 carbon atoms in the backbone and cycloaliphatic dicarboxylates having 8 to 12 carbon atoms in the backbone. The one or more dihydrocarbyl dicarboxylates comprise one or more malonates, terephthalates, phthalates, isophthalates, naphthalene-2,6-dicarboxylates, 1,3-phenylenedioxy diacetates, cyclohexane-dicarboxylates, cyclohexanediacetates, diphenyl-4,4′-dicarboxylates, succinates, glutarates, adipates, azelates, sebacates, or mixtures thereof. The one or more dihydrocarbyl dicarboxylates may comprise one or more malonates. The one or more dihydrocarbyl dicarboxylates correspond to the following formula:

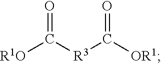

wherein R¹ is as previously described; and
R³ is separately in each occurrence a hydrocarbylene group having two bonds to the carbonyl groups of the diester wherein the hydrocarbylene group may contain one or more heteroatoms. R³ may be separately in each occurrence arylene, cycloalkylene, alkylene or alkenylene. R³ may be separately in each occurrence C₈₋₁₄ arylene, C₈₋₁₂ cycloalkylene, C1-12 alkylene or C₂₋₁₂ alkenylene. R³ may be methylene.

Some of the methods for the preparation of the polyester macromers involve the preparation of intermediate compounds. One class of intermediate compounds is the multifunctional monomers. The multifunctional monomers may be prepared from 1,1-diester-1-alkenes and polyols, including diols. Where the polyol has greater than two hydroxyl groups, preparation of a multifunctional monomer is desired before chain extension. Multifunctional monomers comprise a polyol wherein at least two of the hydroxyl groups are replaced by the residue of 1,1-diester-1-alkenes. Where there are greater than two hydroxyl groups on the polyol it is possible that not all of the hydroxyl groups react with 1,1-diester-1-alkenes.

The 1,1-disubstituted alkene-containing structures, such as polyester macromers, may be used in compositions that are useful in preparing polymers and structures from the polymers. The compositions may be assembled by blending the 1,1-disubstituted alkene-containing structures, such as polyester macromers, with desired components. The compositions may comprise or include mixtures of compounds formed in the preparation of the 1,1-disubstituted alkene-containing structures or polyester macromers. Other ingredients may be added to the mixtures of compounds formed in the preparation of the 1,1-disubstituted alkene-containing structures or polyester macromers to form compositions which are designed to be used in the preparation of polymers containing the 1,1-disubstituted alkene-containing compounds, polyester macromers or structures formed from the polymers or polyester macromers.

The formed compositions may further contain one or more wetting or levelling agents which facilitate the application of such compositions to substrates. Any wetting and or levelling agent which enhances the application of the compositions to a substrate may be used. Exemplary classes of wetting or levelling agents include polyether modified polydimethyl siloxanes, fluorinated hydrocarbons and the like. The wetting agents may be polyether modified polydimethyl siloxanes. The wetting and/or levelling agents are present in sufficient amount to facilitate application of the compositions to a substrates surface. The wetting agents may be present in an amount of about 0.01 percent by weight or greater of the composition, about 0.5 percent by weight or greater or about 5 percent by weight or greater. The wetting agents may be present in an amount of about 5 percent by weight or less of the composition, about 2 percent by weight or less or about 1 percent by weight or less. The formed compositions may further contain one or more UV stabilizers which inhibit the degradation of structures containing the 1,1-disubstituted alkene-containing compounds, such as polyester macromers. Any UV stabilizer which inhibits degradation due to exposure to UV rays may be used. Exemplary classes of ultraviolet light stabilizers include benzophenones, benzotriazoles and hindered amines (commonly known as hindered amine light stabilizers (HALS). Exemplary UV light stabilizers include Cyasorb UV-531 2-hydroxy-4-n-octoxybenzophenone, Tinuvin 571 2-(2H-benzotriazol-2-yl)-6-dodecyl-4-methylphenol, branched and linear Tinuvin 1,2,3 bis-(1-octyloxy-2,2,6,6, tetramethyl-4-piperidinyl) sebacate and Tinuvin 765, bis(1,2,2,6,6,-pentamethyl-4-piperidinyl) sebacate. The UV light stabilizers are present in sufficient amount to enhance durability of the compositions containing 1,1-disubstituted alkene-containing compounds, such as polyester macromers. The UV light stabilizers may be present in an amount of about 0.01 percent by weight or greater of the composition, about 0.1 percent by weight or greater or about 0.2 percent by weight or greater. The UV light stabilizers may be present in an amount of about 5 percent by weight or less of the composition, about 3 percent by weight or less, about 2 percent by weight or less or about 1 percent by weight or less. The composition may further comprise defoamers and/or deaerators. The compositions containing 1,1-disubstituted alkene-containing compounds may foam during processing which can cause problems with respect to surface and appearance of the coating. Any defoamer and/or deaerator which prevents foaming or the formation of bubbles and which does not negatively impact the properties of the composition may be used. Exemplary defoamers are silicone defoamers, silicone free defoamers, polyacrylate defoamers, mixtures thereof and the like. Exemplary defoamers include FOAM BLAST™ 20F, FOAM BLAST™ 30 silicone defoaming compounds and FOAM BLAST™550 polyacrylate defoamers available from Emerald; TEGO AIREX™ 920 polyacrylate defoamer and TEGO AIREX™ 980 from Degussa, SILMER ACR™ Di-10 and ACR™ Mo-8 polydimethylsiloxane acrylate copolymer from Siltech Corporation, FOAMEX N™ or TEGO AIREX™ 900 silicone based defoamers available from Degussa or BYK™ 1790 silicone-free defoamer from BYK Chemie. The defoamer/deaerator may be present in the 1,1-disubstituted alkene-containing compounds or polyester macromer compositions in a sufficient amount to prevent formation of bubbles and/or foam. If too much is used, adhesion to the desired surfaces and adhesives may be negatively impacted. The defoamer and/or deaerator may be present in an amount of about 0.05 percent by weight or greater based on the weight of the composition and more preferably about 0.1 percent by weight or greater. The defoamer/deaerator may be present in an amount of about 2.0 percent by weight or less or about 1.0 percent by weight or less based on the weight of the composition.

These compositions may contain an additive to improve scratch resistance. Any additive which improves scratch resistance may be utilized. Exemplary scratch resistance additives may include, silicates, aluminas, zirconias, carbides, oxides, nitrides or any other fillers with high hardness. Classes of scratch resistance additives may include alumina (e.g., alpha alumina), silica, zirconia, boron carbide, silicon carbide, cerium oxide, glass, diamond, aluminum nitride, silicon nitride, yttrium oxide, titanium diboride, aluminosilicates (i.e. “Zeeospheres” from 3M), titanium carbide, combinations thereof, and the like. Classes of scratch resistance additives are silicates and aluminas. Exemplary scratch resistance additives may include nanometer sized silica fillers. The scratch resistance additives may have a particle size of about 10 micrometers or less or about 5 micrometers or less. The scratch resistance additives may be present in a sufficient amount to enhance the surface hardness and abrasion resistance of a coating and in an amount such that a homogeneous dispersion can be prepared. The scratch resistance additives may be present in an amount of about 0.1 percent by weight or greater of the composition or about 0.5 percent by weight or greater. The scratch resistance additives may be present in an amount of about 5 percent by weight or less of the composition, about 2 percent by weight or less or about 1 percent by weight or less.

Polymeric compositions may comprise one or more other fillers, such as a filler particle (e.g., fibers, powders, beads, flakes, granules, and the like). The filler particle may be a fiber (e.g., having an aspect ratio of the longest direction to each perpendicular direction that is greater than 10). The filler particle may be a particle that is not a fiber (e.g., having an aspect ratio of the longest direction to a perpendicular direction that is less than 10, less than 8, or less than 5). The filler may be formed of an organic material and/or an inorganic material. Examples of organic fillers include fillers derived from biomass and fillers derived from polymers. Inorganic fillers include, nonmetallic materials, metallic materials, and semiconductor material. For example, the filler particle may include alumina silicate, aluminum hydroxide, alumina, silicon oxide, barium sulfate, bentonite, boron nitride, calcium carbonate (e.g., activated calcium carbonate, light calcium carbonate, or heavy calcium carbonate), calcium hydroxide, calcium silicate, calcium sulfate, carbon black, clay, cotton flock, cork powder, diatomaceous earth, dolomite, ebonite powder, glass, graphite, hydrotalcite, iron oxide, iron metallic particles, kaolin, mica, magnesium carbonate, magnesium hydroxide, magnesium oxide, phosphide, pumice, pyrophyllite, sericite, silica, silicon carbide, talc, titanium oxide, wollastonite, zeolite, zirconium oxide, or any combination thereof. The filler particles may be present at a concentration of about 0.1 weight percent or more, about 1 weight percent or more, about 5 weight percent or more, or about 10 weigh percent or more. The filler particles may be present at a concentration of about 70 weight percent or less, about 50 weight percent or less, about 35 weight percent or less, or about 25 weigh percent or less. The filler particles preferably have one, two, or three dimensions that are about 1 mm or less, about 0.3 mm or less, about 0.1 mm, about 50 μm or less, about 10 μm or less. The filler particles preferably have one, two, or three dimensions that are about 0.1 μm or more, about 0.3 μm or more, or about 1 μm or more.

The polymeric compositions according to the teachings herein may include a plasticizer for adjusting the properties of the final polymer for the desired use. The plasticizer may be added prior to, during, or after polymerization. For example, in certain embodiments, a suitable plasticizer can be included with the 1,1-disubstituted alkene monomer. Generally, suitable plasticizers can include plasticizers used to modify the rheological properties of adhesive systems including, for example, straight and branched chain alkyl-phthalates such as diisononyl phthalate, dioctyl phthalate, and dibutyl phthalate, as well as partially hydrogenated terpene, trioctyl phosphate, epoxy plasticizers, toluene-sulfamide, chloroparaffins, adipic acid esters, sebacates such as dimethyl sebacate, castor oil, xylene, 1-methyl-2-pyrrolidione and toluene. Commercial plasticizers such as HB-40 manufactured by Solutia Inc. (St. Louis, Mo.) can also be suitable.

These compositions may comprise an additive to improve surface slip properties. Any known composition that improves surface slip properties may be used. Exemplary surface slip additives may be a polyester modified polydimethyl siloxanes, waxes and the like. Exemplary waxes include those based on polyethylene, polytetrafluoroethylene or polypropylene wax dispersions in acrylate monomers, such as the EVERGLIDE™ or S-395 or SST series of products from Shamrock Technologies, or polyamide particles such as ORGASOL™ from Arkema, or montan wax with reactive acrylate groups, such as CERIDUST™ TP 5091 from Clariant, or CERAFLOUR™ wax powders from Byk-Chemie. The wax may be in powder form having a particle size which is smaller than the desired thickness of a coating prepared from the composition. The maximum particle size may be about 30 microns or less, about 25 microns or less, about 20 microns or less or about 15 microns or less. The wax may be highly crystalline. Exemplary waxes comprise a polyethylene, polypropylene, polyamide, polytetrafluoro-ethylene, or blends and/or copolymers thereof. The wax may be crystalline polyethylene or polytetrafluoroethylene or blends of polyethylene with polytetrafluoroethylene. The surface slip additives may be present in an amount of about 0.1 percent by weight or greater of the composition or about 0.5 percent by weight or greater. The surface slip additives may be present in an amount of about 5 percent by weight or less of the composition, about 2 percent by weight or less or about 1 percent by weight or less.

The compositions as disclosed herein may include one or more initiators for initiating polymerization and/or curing under curing conditions. The curing conditions may cause formation of free radicals. When exposed to irradiation, the initiator may initiate free radical polymerization, anionic polymerization, cross-linking of the composition, or a combination thereof. Therefore, the compositions may include one or more photoinitiators. The compositions may include one or more photobase generators. The photoinitiators supply to the molecules containing unsaturation or to the initiator part of the energy transmitted by the light. Examples of initiators include alpha aminoketones, alpha hydroxyketones, phosphine oxides, phenylglyoxalates, thioxanthones, benzophenones, benzoin ethers, oxime esters, amine synergists, maleimides, mixtures thereof and the like. Initiators may include compounds in the following categories: phosphine oxides, ketones and their derivatives, benzophenones, carbocyanines and methines, polycyclic aromatic hydrocarbons, such as anthracene or the like, and dyestuffs, such as xanthenes, safranines and acridines. These initiators may be chemical substances belonging to one of the following major categories: compounds containing carbonyl groups, such as pentanedione, benzil, piperonal, benzoin and its halogenated derivatives, benzoin ethers, anthraquinone and its derivatives, p,p′-dimethylaminobenzophene, benzophenone and the like; compounds containing sulfur or selenium, such as the di- and polysulfides, xanthogenates, mercaptans, dithiocarbamates, thioketones, beta-napthoselenazolines; peroxides; compounds containing nitrogen, such as azonitriles, diazo compounds, diazides, acridine derivatives, phenazine, quinoxaline, quinazoline and oxime esters, for example, 1-phenyl-1,2-propanedione 2-[0-(benzoyl)oxime]; halogenated compounds, such as halogenated ketones or aldehydes, methylaryl halides, sulfonyl halides or dihalides; phosphine oxides and photoinitiator dyestuffs, such as diazonium salts, azoxybenzenes and derivatives, rhodamines, eosines, fluoresceines, acriflavine or the like. The initiators may include 1,1 dibenzoyl ferrocene, 2-methyl-4′-(methylthio)-2-morpholinopropiophenone, the salt of tributylamine and tetraphenylborate (TBA.BPh₄), isopropylthioxanthone, or a combination thereof.

The initiator may be present in a sufficient amount to catalyze polymerization when exposed to appropriate polymerization conditions as described hereinafter. The initiator may be present in an amount of about 0.05 percent by weight or greater based on the weight of the composition, about 0.1 percent by weight or greater, or about 1 percent by weight or greater. The initiator may present in an amount of about 20 percent by weight or less, about about 10 percent by weight or less, or about 6 percent by weight or less based on the weight of the composition.

The polymers according to the teachings herein preferably adhere to one or more of the following substrates: aluminum, steel, glass, silicon, or wood. For example, when separating two substrates having the polymer placed between the substrates, the separation of the substrates may result in cohesive failure of the polymer, where some polymer remains on the surfaces of the substrates.

The polymers according to the teachings herein may be employed in extruded, blow molded, injection molded, thermoformed, or compression molded articles. The polymers may be employed as an adhesive. For example, the polymers may be employed in a pressure sensitive adhesive composition. The polymers may be employed as a coating, such as a protective coating. The polymer may be employed as a primer layer over a substrate.

The 1,1-disubstituted alkene-containing compounds, which may be polyester macromers, and compositions containing them may be used in the preparation of polyester based structures, such as coatings on substrates, films, fibers, adhesives and the like. While polyester macromers are disclosed, it is understood that any 1,1-disubsituted alkene-containing compound is within the scope of the teachings. A coating containing 1,1-disubstituted alkene-containing compounds, polyester macromers, and/or the residue of the polyester macromers can be disposed on one or more surfaces or a portion thereof of a substrate. The films, coatings, or other structures may be cured and/or crosslinked. The crosslinked compositions may be crosslinked through the alkene groups pendant from the macromer chains. The crosslink may be a direct bond between the alkene groups of adjacent macromer chains. The macromer chains may be included in prepolymer or polymer chains. The macromer chains may be crosslinked through any compound having unsaturation that polymerizes by anionic or free radical polymerization. The 1,1-disubstituted alkene-containing compounds or polyester macromer chains may be crosslinked through 1,1-diester alkenes wherein the crosslinks comprise the residue of the 1,1-diester alkenes. The 1,1-disubstituted alkene-containing compounds or polyester macromer chains may be crosslinked through multifunctional monomers wherein the crosslinks comprise the residue of the multifunctional monomers. The crosslinks between chains may be illustrated by the following formula:

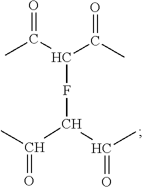

wherein F is separately in each occurrence a direct bond, the residue of a compound that polymerizes with an unsaturated group by anionic polymerization or free radical polymerization. F may be separately in each occurrence a direct bond, the residue of a 1,1-diester-1-alkene or a multifunctional monomer. The crosslink density of a crosslinked composition containing the 1,1-disubstituted alkene-containing compounds or polyester macromers may be any such density that provides the desired properties of the composition.

The films or coatings may have a thickness of about 0.01 micrometers or greater, about 0.04 micrometers or greater, about 0.1 micrometers or greater, about 0.5 micrometers or greater, or about 1 micrometer or greater. The film or coating may be cured and/or crosslinked. The film or coating may have a thickness of about 500 micrometers or less, about 350 micrometers or less, about 160 micrometers or less, about 100 micrometers or less, about 80 micrometers or less or about 60 micrometers or less, about 20 micrometers or less, or about 1 micrometer or less. Disclosed are articles comprising a substrate with a coating comprising one or more 1,1-disubstituted alkene compounds, which may be polyester macromers, or a composition containing one or more 1,1-disubstituted alkene compounds applied to one or more surfaces.

The 1,1-disubstituted alkene-containing compounds and compositions containing them may undergo polymerization when exposed to basic cure initiators. If applied to the surface of a substrate that is basic, the 1,1-disubstituted alkene-containing compounds will cure via anionic polymerization. Therefore, disclosed is a method comprising contacting a composition containing one or more 1,1-disubstituted alkene-containing compounds, as disclosed herein with a surface of a substrate, wherein the surface is at least mildly basic, and forming a coating on the surface of the substrate comprising the composition. The substrate may comprise a material that is at least mildly basic. The substrate itself may be at least mildly basic. The substrate may include a pre-treatment that is at least mildly basic. A composition that contains a basic compound that initiates anionic polymerization for 1,1-disubstituted alkenes or polyester macromers may be applied to the surface of the substrate before applying the composition containing one or more 1,1-disubstituted alkene compounds or polyester macromers. Exemplary basic compounds comprise one or more amines; polyamine basic pigments; polyalkyleneamines; polyethylene imines; and carboxylate salts. Anionic polymerization may be initiated upon contact between the coating or composition to the at least mildly basic substrate. This anionic polymerization may be initiated without exposing the coating or composition to further conditions. This anionic polymerization may take place at ambient temperatures. The coatings may also be cured with no heat input, at ambient temperatures, such as with UV radiation.

Disclosed are also articles comprising substrates containing base coats on the substrates with coatings containing 1,1-disubstituted alkene-containing compounds disclosed herein disposed on the base coats. The base coats may have a basic character which is sufficient to cure and/or crosslink the 1,1-disubstituted alkene-containing compounds, such as polyester macromers. The coatings containing the 1,1-disubstituted alkene-containing compounds may be clear and function as clear coats.

Disclosed is also a method comprising contacting a composition containing one or more 1,1-disubstituted alkene-containing compounds with a surface of a substrate wherein the surface is at least mildly basic and forming a coating on the surface of the substrate comprising the composition containing the one or more 1,1-disubstituted alkene-containing compounds, which may include polyester macromers. The substrate may comprise material that is basic. The composition that contains a basic compound may be applied to the surface of the substrate before applying the composition containing one or more 1,1-disubstituted alkene-containing compounds. The composition that contains a basic compound may comprise any compound disclosed herein as an anionic polymerization inhibitor useful with 1,1-diester-1-alkenes. Exemplary basic compounds include an amine, polyamine basic pigments or carboxylate salts. The composition that contains a basic compound may comprise a polyalkyleneimine. The method may further include exposing the substrate with the composition containing one or more 1,1-disubstituted alkene-containing compounds to a temperature of about 20° C. or greater or about 50° C. or greater. The method may further include exposing the substrate to with a composition containing one or more 1,1-disubstituted alkene-containing compounds to a temperature of about to 150° C. or less or about 120° C. or less. The time period for such exposure may be about 10 minutes or greater or 20 minutes or greater. The time period for such exposure may be 120 minutes or less, about 60 minutes or less, or about 30 minutes or less. The exposure is performed under conditions such that the coating containing one or more 1,1-disubstituted alkene-containing compounds disposed on the surface of the substrate is cured and/or crosslinked. The contacting of the composition with the surface of the basic substrate, therefore, may initiate anionic polymerization or curing, especially at the interface between the surface of the substrate and the composition. The coatings or films may cure and/or crosslink when exposed to certain conditions. When the coating or film is exposed to relatively strong bases, elevated temperatures, or both, it may cure and crosslink at the same time.

The formulation as disclosed herein may include contacting the one or more initiators, such as photoinitiators and/or photobase generators, with a composition including one or more 1,1-disubstituted alkene compounds. The one or more photoinitiators and/or photobase generators may induce free radical polymerization, anionic polymerization, or both, upon exposure to ultraviolet radiation. This polymerization may be instead of or addition to the anionic polymerization or curing at the interface between the coating or film and the surface of the substrate. For example, anionic polymerization may occur at the interface between the coating or film and the surface of the substrate, and the opposing surface of the coating or film may undergo free radical or anionic polymerization upon exposure to ultraviolet radiation. This may provide surface cure at both surfaces of the coating or film, cure through the entire thickness of the coating or film, or both.

Disclosed is a method of contacting one or more initiators, such as a photoinitiator or photobase generator, with the composition including one or more 1,1-disubstituted alkene compounds as described herein, and exposing the formulation to ultraviolet radiation. The composition including one or more 1,1-disubsituted alkene compounds may be exposed to ultraviolet light having an irradiance of about 0.5 watts/cm² or more, about 1 watt/cm² or more, or about 1.5 watts/cm² or more. The ultraviolet light may have an irradiance of about 5 watts/cm² or less, about 4.5 watts/cm² or less, or about 4 watts/cm² or less. The ultraviolet light may have a wavelength of about 250 nanometers or more, about 300 nanometers or more, or about 325 nanometers of more. The ultraviolet light may have a wavelength of about 400 nanometers or less, about 390 nanometers or less, or about 375 nanometers or less. For example, the ultraviolet light may be emitted between about 325 nanometers and about 375 nanometers. The formulation may be exposed to the ultraviolet light for about 240 seconds or less, about 180 seconds or less, about 120 seconds or less, about 90 seconds or less, about 60 seconds or less, or about 30 seconds or less. Upon exposure to the ultraviolet light source, surface cure of the formulation, or complete cure of the formulation may be observed. The surface of the cured formulation may be tack free. The ability to cure compositions including one or more 1,1-disubstituted alkene compounds by free radical photoinitiator chemistry and/or anionic photolatent base chemistry may provide advantages, particularly in thin coatings, where the surface can be cured by UV irradiation and the remainder of the coating can be cured by anionic surface initiation. The combination of free radical and anionic chemistry may help overcome limitations of current free radical chemistry.

The composition or film may be capable of curing multiple ways. The composition may undergo dual curing. For example, the composition may undergo both anionic polymerization and free radical polymerization. The composition may be applied to a substrate having at least a mildly basic surface (e.g., as a property of the substrate or due to the application of a basic coating) to initiate anionic polymerization at the area contacting the basic surface or substrate. Free radical polymerization may be initiated on the opposing side of the composition or film. The surface of the composition or film facing away from the substrate to which it is applied may be exposed to radiation, such as ultraviolet radiation. Upon exposure to the radiation, free radical polymerization may be initiated. The dual curing of the composition or film may allow for curing through at least a portion of the thickness of the composition. The dual curing may allow for curing through the entire thickness of the composition or film for a complete, tack-free cure.

### ILLUSTRATIVE EXAMPLES

The following examples are provided to illustrate the teachings herein, but are not intended to limit the scope thereof. All parts and percentages are by weight unless otherwise indicated.

### Example 1

Formulations including diethyl methylene malonate monomer (DEMM) are contacted with one or more initiators, as shown in Table 1. Difunctionality is introduced into the system with the addition of 1,6 pentanediol DEMM crosslinker. Around 2 g of each formulation is dispensed in an aluminum pan with a plastic pipette and exposed to a UV LED light source that emits at 365 nm or a period of less than 30 seconds. Thickness of the cured film is measured after complete cure was observed.

TABLE 1

| Formu- | | | |
|---|---|---|---|
| lation | Monomer | Initiator | Observation |
| 1 | DEMM | Dibenzoyl ferrocene | Good surface |
| | (97% pure) | (2.5%) | cure |
| 2 | DEMM | 2-methyl-4′-(methylthio)-2- | Good through |
| | (97% pure) | morpholinopropiophenone | cure |
| | | (2.5%) | |
| 3 | DEMM | TBA.BPh₄ + | Gelation; no |
| | (97% pure) | isopropylthioxanthone | full cure |
| | | (synergist) | |
| | | (2.5%) | |
| 4 | Difunctional | Dibenzoyl ferrocene | Wrinkled film; |
| | DEMM | (5%) | cured at surface |
| | (8% blend | | |
| | in dEMM) | | |
| 5 | Difunctional | 2-methyl-4′-(methylthio)-2- | Complete cure; |
| | DEMM | morpholinopropiophenone | tack free |
| | (8% blend | (5%) | surface |
| | in dEMM) | | |
| 6 | Difunctional | TBA.BPh₄ + | Wrinkled film; |
| | DEMM | isopropylthioxanthone | cured at surface |
| | (8% blend | (synergist) | |
| | in dEMM) | (5% + 2%) | |
| 7 | Difunctional | Dibenzoyl ferrocene | Complete cure; |
| | DEMM | (1%) | tack free |
| | (25% blend | | surface |
| | in dEMM) | | |
| 8 | Difunctional | TBA.BPh₄ + | Incomplete cure |
| | DEMM | isopropylthioxanthone | |
| | (25% blend | (synergist) | |
| | in dEMM) | (1% + 0.5%) | |
| 9 | DEMM + | 2-methyl-4′-(methylthio)-2- | Complete cure; |
| | methyl | morpholinopropiophenone | tack free |
| | methacrylate | (3%) | surface |
| 10 | Difunctional | 2-methyl-4′-(methylthio)-2- | Complete cure; |
| | DEMM | morpholinopropiophenone | tack free |
| | (25% | (3%) | surface |
| | blend) + methyl | | |
| | methacrylate | | |

Upon exposure to UV radiation, increase in viscosity has been observed for each formulation over time. Free radical polymerization is observed upon using 2-methyl-4′-(methylthio)-2-morpholinopropiophenone as an initiator. The results in Table 1 show that methylene malonates can be cured by free radical photoinitiator chemistry, by anionic photolatent base chemistry, or both. Free radical cure has demonstrated better depth of cure. Anionic cure can be used to eliminate the oxygen inhibition effect on the surface of the cured material.

### Example 2

The following formulations were mixed and poured into an aluminum dish. The formulations were polymerized under a UV lamp with a feed rate of 5 ft/min using a mercury lamp at a relative intensity of 5000 mJ/cm². The resulting cured materials were analyzed for hardness with a Shore D hardness gauge. Cure depth was also measured.

TABLE 2
Formulation Percentage Composition and Monomer Purity

| | Aliphatic | | | Monomer purity |
|---|---|---|---|---|
| | urethane | Monomer | Irgacure | & BHT level |
| Formulation | acrylate (CN981) | (diluent) | 907 | (GC-FID) |
| FM1 | 67% | 30% IBOA | 3% | 92% (no BHT |
| | | | | detected) |
| FM2 | 67% | 30% DCHMM | 3% | 97% (1224 |
| | | | | ppm BHT) |

In both cases, the samples were cured to a depth greater than 5 mm. The shore D hardness for FM 1 was 65 and the hardness for FM 2 was 52.

The crosslink density of cured samples was tested by exposing to dichloromethane for 24 hours at room temperature to solvate the chains and leach out any uncrosslinked fractions. The crosslinked fraction was determined gravimetrically after filtering and drying the polymer in a vacuum oven for 3 hours. The extractable material was characterized by GCMS to determine the composition after solvent flash-off. The swell test, MEK resistance, and extractable data is summarized in the table below.

TABLE 3
Performance Data

| | % crosslinked | Shore D | MEK | % |
|---|---|---|---|---|
| | fraction | Hardness | Resistance | leachables |
| Formulation | (Swell test) | (at t = 0) | (top surface) | (by GC-MS) |
| FM1 (with | 90% | 65 | 200 double | 62% IBOA, |
| IBOA) | | | wipes | 33% Irgacure |
| | | | | 907 |
| FM2 (with | 83% | 52 | 200 double | 55% DCHMM, |
| DCHMM) | | | wipes | 34% Irgacure |
| | | | | 907 |

The above shows that DCHMM can be copolymerized free radically in presence of radical initiator and UV light to yield a hybrid polymer with performance comparable to that obtained using corresponding high Tg acrylate monomer (IBOA). The relative differences between the performance of the cured material for the two compositions can be related to the amount of radical stabilizer BHT present in DCHMM. This negatively impacted free radical curing efficiency and resulted in marginally lower performance.

### Example 3

0.1 wt % of dibenzoyl ferrocene was added to a sample of Forza P1000 (enzymatically synthesized pentane diol based crosslinker in DEMM solution) as a photobase generator. Ferrocene based photobase generators have been used in dual cure cyanoacrylate based systems (U.S. Pat. No. 6,867,241, which is incorporated herein by reference in its entirety for all purposes). The DEMM based system was used to better dissolve the dibenzoyl ferrocene and to maximize the possible anionic polymerization after the photo base generated nucleophilic species.

The resultant formulation was exposed to mercury lamp UV radiation for 5 passes at a feed rate of 5 ft/minute resulting in a one-pass intensity of 5000 mJ/cm². While anionic polymerization was initiated and resulted in the formation of chunks of polymer, complete cure across the cross section was not observed. The poor nucleophilicity of the base generated by the photodegradation of dibenzoyl ferrocene apparently resulted in insufficient propagation. The above demonstrates that methylene malonates can undergo anionic polymerization in the presence of photobase generators when exposed to UV light.

Any numerical values recited include all values from the lower value to the upper value in increments of one unit provided that there is a separation of at least 2 units between any lower value and any higher value. For values which are less than one, one unit is considered to be 0.0001, 0.001, 0.01 or 0.1 as appropriate. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

What is claimed is:

1. A method comprising forming a formulation by contacting one or more photoinitiators with a composition including one or more 1,1-disubstituted alkene compounds having a purity of about 85 mole percent or more based on total weight of the 1,1-disubsituted alkene compounds; and exposing the formulation to ultraviolet radiation for initiating free radical polymerization, anionic polymerization, or both, to cure the formulation to form a non-tacky surface.

2. The method of claim 1, wherein the one or more 1,1-disubstituted alkene compounds corresponds to Formula 1: 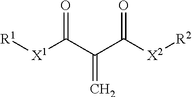
wherein X¹ and X², separately in each occurrence, are an oxygen atom or a direct bond; and
wherein R¹ and R², separately in each occurrence, are hydrocarbyl groups that are the same or different.

3. The method of claim 2, wherein the one or more 1,1-disubstituted alkene compounds include ester groups corresponding to Formula 1A: 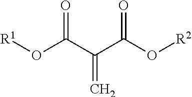
wherein R¹ and R², separately in each occurrence, are hydrocarbyl groups that are the same or different.

4. The method of claim 2, wherein the one or more 1,1-disubstituted alkene compounds include keto groups corresponding to Formula 1B: 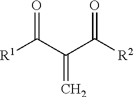
wherein R¹ and R², separately in each occurrence, are hydrocarbyl groups that are the same or different.

5. The method of claim 2, wherein the one or more 1,1-disubstituted alkene compounds include one or more ester groups and one or more keto groups corresponding to Formula 1C: 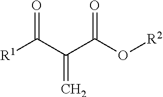
wherein R¹ and R², separately in each occurrence, are hydrocarbyl groups that are the same or different.

6. The method of claim 2, wherein the one or more 1,1-disubstituted alkene compounds are multifunctional monomers corresponding to Formula 1D: 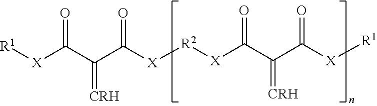
wherein X, separately in each occurrence, is an oxygen atom or a direct bond;
wherein R¹ and R², separately in each occurrence, are hydrocarbyl groups that a the same or different; and
n is an integer of 1 or greater.

7. The method of any of claims 1 to 3, wherein the one or more 1,1-disubstituted alkene compounds are methylene malonate monomers.

8. The method of any of the preceding claims, wherein the one or more photoinitiators include alpha aminoketones, alpha hydroxyketones, phosphine oxides, phenylglyoxalates, thioxanthones, benzophenones, benzoin ethers, oxime esters, amine synergists, maleimides, or mixtures thereof.

9. The method of any of the preceding claims, wherein the one or more photoinitiators are selected from 1,1-dibenzoyl ferrocene, 2-methyl-4′-(methylthio)-2-morphlinopropiophenone, the salt of tributylamine and tetraphenylborate, isopropylthioxanthone, or a combination thereof.

10. The method of any of the preceding claims, wherein the photoinitiator is added to the composition including 1,1-disubstituted alkene compounds in an amount of about 0.1 percent by weight to about 6 percent by weight.

11. The method of any of the preceding claims, wherein the composition includes 1,1-disubstituted alkene compounds having two or more core units bound together through a hydrocarbylene linkage between one oxygen atom on each of two or more core formulas.

12. The method of any of the preceding claims, wherein the composition includes one or more (meth)acrylates or any other alkene containing unsaturated molecule that can be polymerized by free radicals.

13. The method of any of the preceding claims, wherein the method is performed at ambient temperatures.

14. The method of any of the preceding claims, wherein the ultraviolet light has an irradiance between about 1 watt/cm² and about 5 watts/cm² and a wavelength of about 250 nanometers to about 400 nanometers.

15. The method of claim 9, wherein the ultraviolet light is emitted at about 325 nanometers to about 375 nanometers.

16. The method of any of the preceding claims, wherein the formulation is cured in the form of a film or coating.

17. The method of claim 16, wherein the film or coating is a tack-free film upon exposure to ultraviolet light.

18. The method of any of the preceding claims, wherein the formulation is exposed to ultraviolet light for about 3 minutes or less.

19. The method of claim 18, wherein the formulation is exposed to ultraviolet light for about 60 seconds or less.

20. A method comprising contacting the formulation of any of the preceding claims with a surface of a substrate, wherein the surface is at least mildly nucleophilic; and exposing the formulation to ultraviolet light; wherein the formulation is cured through its entire thickness.

21. The method of claim 20, wherein the formulation is cured by a combination of free radical cure and anionic cure.

22. The method of claim 20 or 21, wherein the substrate has a pigmented coating deposited on its surface wherein the pigmented coating is mildly basic or nucleophilic.

23. The method of any of the preceding claims, wherein the purity is about 90 mole percent or more based on the total weight of the 1,1-disubsituted alkene compound.

24. The method of any of the preceding claims, wherein the purity is about 97 mole percent or more based on the total weight of the 1,1-disubsituted alkene compound.

25. A polymer prepared according to the method of any of the preceding claims.
